(19) United States
(12) Patent Application Publication
(10) Pub. No.: US 2017/0193163 A1
(43) Pub. Date: Jul. 6, 2017

(54) USER DEVICE PLATFORM FOR INTERACTING WITH CLOUD-BASED PLATFORM

(71) Applicant: Accenture Global Solutions Limited, Dublin (IE)

(72) Inventors: Katherine MELLE, Boston, MA (US); John R. SHERMAN, Hoboken, NJ (US); Nicolae E. CECAN, Princeton, NJ (US)

(21) Appl. No.: 15/271,564

(22) Filed: Sep. 21, 2016

Related U.S. Application Data
(60) Provisional application No. 62/273,060, filed on Dec. 30, 2015.
(60) Provisional application No. 62/273,070, filed on Dec. 30, 2015.

(51) Int. Cl. G06F 19/00; G06F 21/62; G06F 3/0482

(52) U.S. Cl. CPC G06F 19/322; G06F 3/0482; G06F 21/6245

(57) ABSTRACT

A device may receive assignment information that identifies one or more operations to be performed with regard to a patient. The device may provide, for display via a user interface, information identifying the one or more operations and first patient information relating to the patient. The first patient information may relate to performance of the one or more operations with regard to the patient. The device may receive, via the user interface, performance information based on performance of the one or more operations, or second patient information relating to the patient. The device may provide the performance information or the second patient information to permit modification of the one or more operations, or assignment of one or more additional operations to be performed, based on the performance information or the second patient information.

### RELATED APPLICATION

This application claims priority under 35 U.S.C. §119 to U.S. Provisional Patent Application No. 62/273,060, filed on Dec. 30, 2015, and to U.S. Provisional Patent Application No. 62/273,070, filed on Dec. 30, 2015, the content of which is incorporated by reference herein in its entirety.

### BACKGROUND

Health related services may be provided at locations that are remote from a conventional office. For example, a health related worker (e.g., a physician, a nurse, a physical therapist, a veterinarian, or the like) may travel to the home of a patient to provide services. Such services may include performing medical examinations, monitoring health conditions, administering medications, providing treatment or therapy, or the like.

### SUMMARY

According to some possible implementations, a device may include one or more processors. The one or more processors may receive assignment information that identifies one or more operations to be performed with regard to a patient. The one or more processors may provide, for display via a user interface, information identifying the one or more operations and first patient information relating to the patient. The first patient information may relate to performance of the one or more operations with regard to the patient. The one or more processors may receive, via the user interface, performance information relating to performance of the one or more operations. The one or more processors may receive, via the user interface, second patient information relating to the patient. The one or more processors may provide the performance information or the second patient information to permit modification of the one or more operations, or assignment of one or more additional operations to be performed, based on the performance information or the second patient information.

According to some possible implementations, a method may include receiving, by a device, assignment information that identifies one or more operations to be performed with regard to a patient. The method may include providing, by the device for display via a user interface, information identifying the one or more operations and first patient information relating to the patient. The first patient information may relate to performance of the one or more operations with regard to the patient. The method may include receiving, by the device, performance information obtained based on performance of the one or more operations. The method may include receiving, by the device, second patient information relating to the patient. The method may include providing, by the device, the performance information or the second patient information to facilitate modification of the one or more operations, or assignment one or more additional operations to be performed, based on the performance information or the second patient information.

According to some possible implementations, a non-transitory computer-readable medium may store one or more instructions that, when executed by one or more processors of a device, may cause the one or more processors to receive assignment information that identifies one or more operations to be performed with regard to a patient. The one or more instructions, when executed by one or more processors of a device, may cause the one or more processors to provide, for display via a user interface, information identifying the one or more operations and first patient information relating to the patient. The first patient information may facilitate performance of the one or more operations with regard to the patient. The one or more instructions, when executed by one or more processors of a device, may cause the one or more processors to receive, via the user interface, performance information that is received based on the one or more operations being performed. The one or more instructions, when executed by one or more processors of a device, may cause the one or more processors to receive, via the user interface, second patient information relating to the patient. The one or more instructions, when executed by one or more processors of a device, may cause the one or more processors to provide the performance information or the second patient information. The one or more instructions, when executed by one or more processors of a device, may cause the one or more processors to receive, based on the performance information or the second patient information, updated assignment information. The updated assignment information may identify one or more additional operations to be performed. The one or more instructions, when executed by one or more processors of a device, may cause the one or more processors to provide, via the user interface, information regarding the one or more additional operations. The information regarding the one or more additional operations may be provided to facilitate performance of the one or more additional operations.

### BRIEF DESCRIPTION OF THE DRAWINGS

FIGS. 1A-1C are diagrams of overviews of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for configuring a set of operations to be performed with regard to a patient;

FIG. 5 is a flow chart of an example process for securely administering and providing information related to performance of a set of operations; and

FIGS. 6A and 6B are diagrams of example user interfaces relating to the example processes shown in FIGS. 4 and 5.

### DETAILED DESCRIPTION

The following detailed description of example implementations refers to the accompanying drawings. The same reference numbers in different drawings may identify the same or similar elements.

An entity, such as a pharmaceutical company, an insurance company, a hospital, a rehabilitation facility, a life sciences entity, a health care facility, or the like, may offer one or more services to a patient, and/or a person associated with the patient, aimed at enhancing a patient experience and/or quality of delivered care. For example, the entity may offer services associated with providing support throughout a treatment, such as a service associated with enrolling the patient for the treatment, a service associated with ensuring that the patient adheres to the treatment, a service associated with supporting the patient throughout the treatment, or the like.

However, provisioning of such patient services may be disjointed and/or separate (e.g., between various teams associated with providing each service), which may negatively impact the patient experience. Moreover, the disjointed and/or separate provisioning of the patient services may prevent the entity from gathering information, associated with the treatment (e.g., patient data, treatment data, data associated with the services, etc.), that, if analyzed, may provide insight into improvement of the services. Furthermore, existing provisioning techniques may also produce delays in updating patient records to accurately reflect the current state of the patient and his/her treatment protocol. For example, patient records may only be updated when a field nurse returns to the office and has time to enter notes into the patient's file. This may lead to field nurses acting based on outdated information and/or information that is not adjusted based on a recent development with regard to the patient.

In order to address these needs, the entity may implement a patient platform (sometimes referred to as a “patient platform” or an “intelligent patient platform”) capable of aggregating the available patient services and/or gathering information associated with the treatment. In some implementations, the patient platform may be cloud-based or partially cloud-based. The patient platform may include, for example, a suite of applications associated with the patient services, such as a patient onboarding application, a patient adherence application, a connected physician application, a field nurse enablement application, or the like.

Implementations described herein may provide an application for assisting a field-based nurse to perform operations associated with one or more patient services, such as patient education, physician education, injection training, patient onboarding, patient adherence, patient treatment or the like. In some implementations, the application (sometimes referred to as a “mobile nurse application” or a “field nurse enablement application”) may work in conjunction with one or more components of the patient platform and/or one or more other applications associated with the patient platform. Furthermore, the application and/or the patient platform may improve security of patient information and/or information relating to the operations. Still further, the application may gather or receive information related to performing the operations, may securely and locally store the information, and may provide the information when a secure connection with the patient platform is established. Thus, the application improves versatility of performance of the operations and improves security of the information by securely storing the information until the information can be transmitted using a secure connection.

In some implementations, the application may permit real-time communication (e.g., real-time, substantially real-time, substantially instantaneous, etc.) between the patient platform and the application. For example, some systems may require a field practitioner to take a manual download (e.g., paper or electronic), from the patient platform before going into the field. As a result, the field practitioner may use static and dated information in the field. When the field practitioner returns from the field, there can be a delay (e.g., of several days, of a few weeks, etc.) until data that is obtained in the field is uploaded and accessible in the patient platform. Implementations described herein permit real-time communication between the patient platform and the application, thus reducing or eliminating the delay in uploading and accessing field data. This, in turn, may permit real-time reconfiguration or adjustment of services to be provided by field nurses or other practitioners.

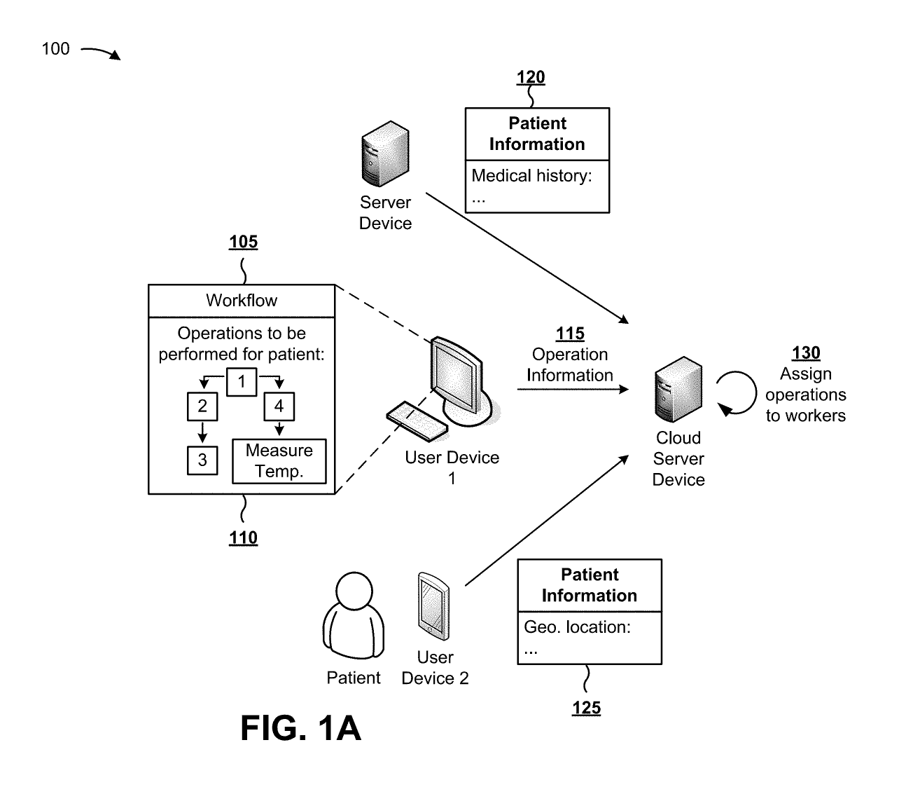

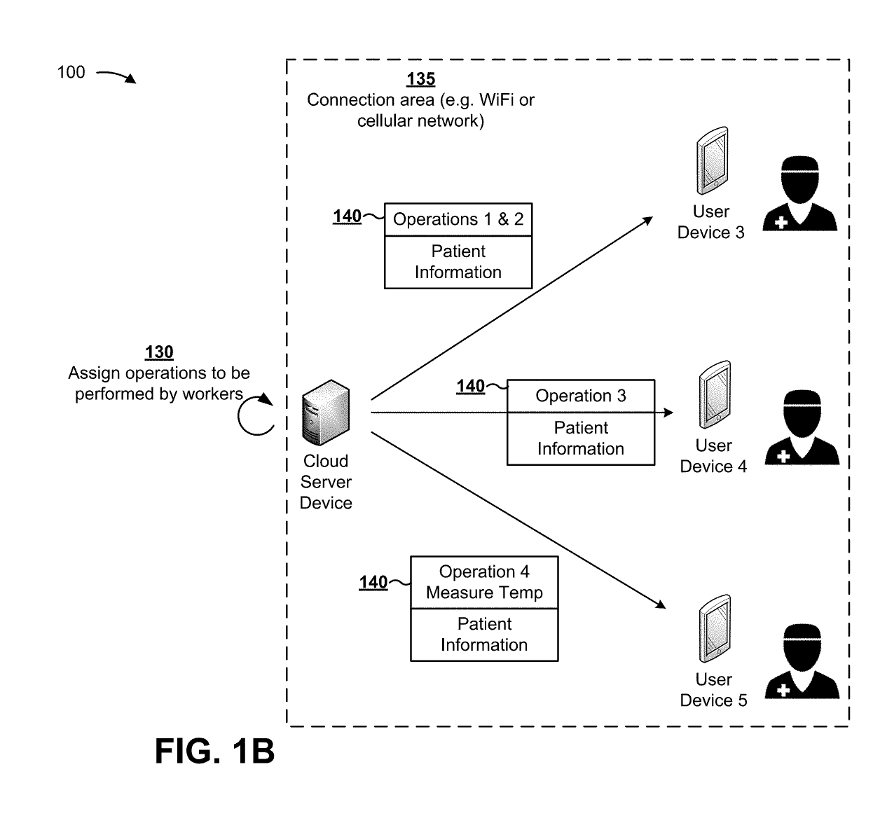

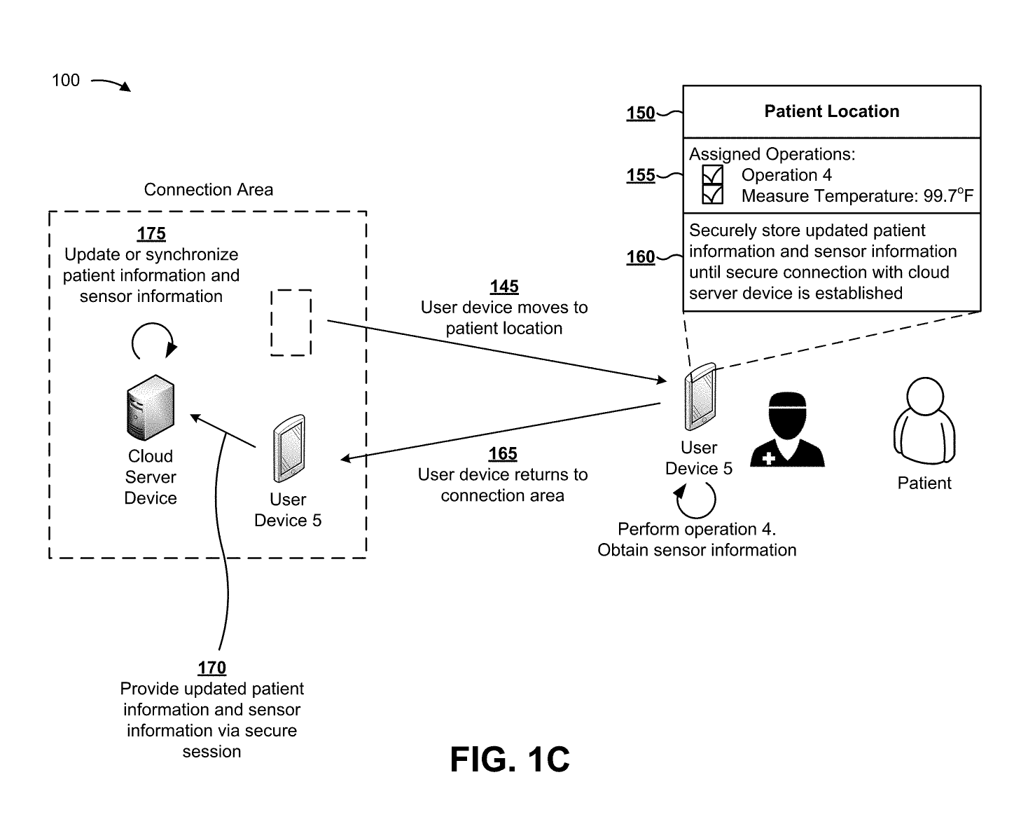

FIGS. 1A and 1B are diagrams of overviews of an example implementation 100 described herein. As shown in FIG. 1A, example implementation 100 may include a cloud server device, a server device, a user device 1, and a user device 2. As shown by reference number 105, a workflow may be generated or received by a user device, such as user device 1. The workflow may include a set of operations to be performed by a worker (e.g., a nurse, a physical trainer, a technician, etc.) with regard to a patient. As shown by reference number 110, the workflow may be associated with operations 1, 2, 3, and 4, and an operation to measure a temperature. The operation to measure the temperature may cause a user device to measure a temperature associated with the patient, as described in more detail elsewhere herein.

As shown by reference number 115, the cloud server device may receive (e.g., from user device 1) operation information (e.g., information identifying the set of operations to be performed). As shown by reference number 120, the cloud server device may also receive (e.g., from the server device) patient information relating to the patient for which the operations are to be performed. For example, the patient information may identify attributes of the patient (e.g., medical history, health indicators, or pharmaceuticals), or similar information. As shown by reference number 125, the cloud server device may also receive (e.g., from user device 2) patient information that identifies a location or geographical area associated with the patient. The geographical location may be used to match operations with workers based on geographical locations of the patient and/or workers.

As shown in FIG. 1B, example implementation 100 may include user devices 3, 4, and 5 (each of which may be associated with a worker providing services to the patient), which may be capable of communication with the cloud server device. For example, user devices 3, 4, and/or 5 may be connected to the cloud server device via a secure connection, such as a cellular connection (e.g., a Third Generation (3G) connection, a Fourth Generation (4G) Long Term Evolution (LTE) connection, etc.), a Wi-Fi connection (e.g., utilizing WPA or WPA2), and/or via the Internet (e.g., utilizing a secure sockets layer (SSL) connection, a virtual private network (VPN), an encrypted session, or the like). As shown by reference number 130, the cloud server device may assign operations to be performed by workers. For example, the cloud server device may assign the operations to be performed by the workers based on locations associated with the workers and/or the patient, based on experience or qualifications of the workers, based on availability of the workers, or the like, as described in more detail elsewhere herein. As shown by reference number 135, the cloud server device may communicate with user devices 3, 4, and 5 in a connection area, within which communication between the cloud server device and the user devices is possible (e.g., within range of a Wi-Fi network or a cellular network). In some implementations, the cloud server device may communicate with the user devices when a secure connection is established.

As further shown in FIG. 1B, the cloud server device may provide assignment information, which may identify assigned operations and/or patient information, to the user devices associated with the workers who are assigned to provide services to the patient. As shown by reference number 140, the cloud server device may provide, to user device 3, assignment information identifying operations 1 and 2 and patient information associated with the patient. As further shown by reference number 140, the cloud server device may provide, to user device 4, assignment information identifying operation 3 and patient information associated with the patient. As further shown by reference number 140, the cloud server device may provide, to user device 5, assignment information identifying operation 4 and the operation to measure a temperature of the patient, and may provide patient information associated with the patient.

In some implementations, the patient information provided to user devices 3, 4, and 5 may pertain only to the respective operations to be performed by the workers associated with the user devices to which the patient information is provided. In some implementations, the patient information provided to each user device may include all of the patient information associated with the patient. Likewise, the assignment information provided to a particular user device may pertain to all operations to be performed, or may include only the operations to be performed by the particular user device. Similarly, the assignment information provided to a particular user device may include all operations that may be performed by the particular user device, or may include only operations ready to be performed, based on dependencies established by the workflow. For example, as the workflow shown in FIG. 1A indicates that operation 1 is to be performed before operations 2 and 4, and that operation 2 is to be performed before operation 3, the cloud server device may provide the assignment information to user device 4 only after obtaining information from user device 3 indicating that operation 2 has been performed, and may provide assignment information to user device 5 only after obtaining information from user device 3 indicating that operation 1 has been performed.

As shown in FIG. 1C, a user device in example implementation 100 may move in or out of the connection area. As shown by reference number 145, for example, a worker using user device 5 may carry user device 5 outside of the connection area based on the geographical location of the patient (e.g., to provide services to the patient when the patient is outside of the connection area). As shown by reference number 150, user device 5 may provide for display (e.g., via a graphical user interface) an indication of the patient location. As shown by reference number 155, user device 5 may also provide for display (e.g., via the graphical user interface) an indication of the operations assigned to the worker associated with user device 5.

Assume that the worker and/or user device 5 perform the operations. For example, the worker may perform operation 4, and user device 5 may obtain a temperature measurement based on a sensor associated with user device 5 (e.g., 99.7 degrees Fahrenheit). As further shown by reference number 155, upon completion of performing the operations, user device 5 may receive user-inputted information to specify completion states of the operations (e.g., by selecting a box displayed by each operation that has been performed, thereby causing user device 205 to display a check mark in the box, as shown).

As shown by reference number 160, user device 5 may securely store the updated patient information until a secure connection with the cloud server device can be established. As shown by reference number 165, user device 5 may return to the connection area (e.g., after the worker leaves the patient location). As shown by reference number 170, based on returning to the connection area, user device 5 may provide the updated patient information to the cloud server device via a secure connection. As shown by reference number 175, the cloud server device may update or synchronize the patient information upon receiving the information from user device 5. In this way, the updated patient information may be captured in real time (e.g., as the patient information is updated), or near real time (e.g., in real time or substantially real time), even when a user device is not connected to the cloud server device, and may still be made available to the cloud server device when it becomes possible to do so in a secure fashion (e.g., as soon as a secure connection may be established).

Implementations described herein enable provisioning of health related services, in locations potentially remote from a computer system where patient information and/or assignment information is maintained, in a way that allows workers providing the health related services to access, utilize and/or update the patient information in real time (or near real time), to securely maintain the patient information, and to provide the patient information to the computer system as soon as it is possible to do so securely. In this way, resources may be saved (e.g., processor, memory and/or storage) that may otherwise have been required to redundantly store or provide information. Furthermore, information asymmetry (e.g., based on out-of-date records) may be reduced. Further still, patient data may be gathered, enriched, and analyzed more efficiently. The provision of patient care and the experience of the patient may thereby be improved.

As indicated above, FIGS. 1A-1C are provided merely as examples. Other examples are possible and may differ from what was described with regard to FIGS. 1A-1C.

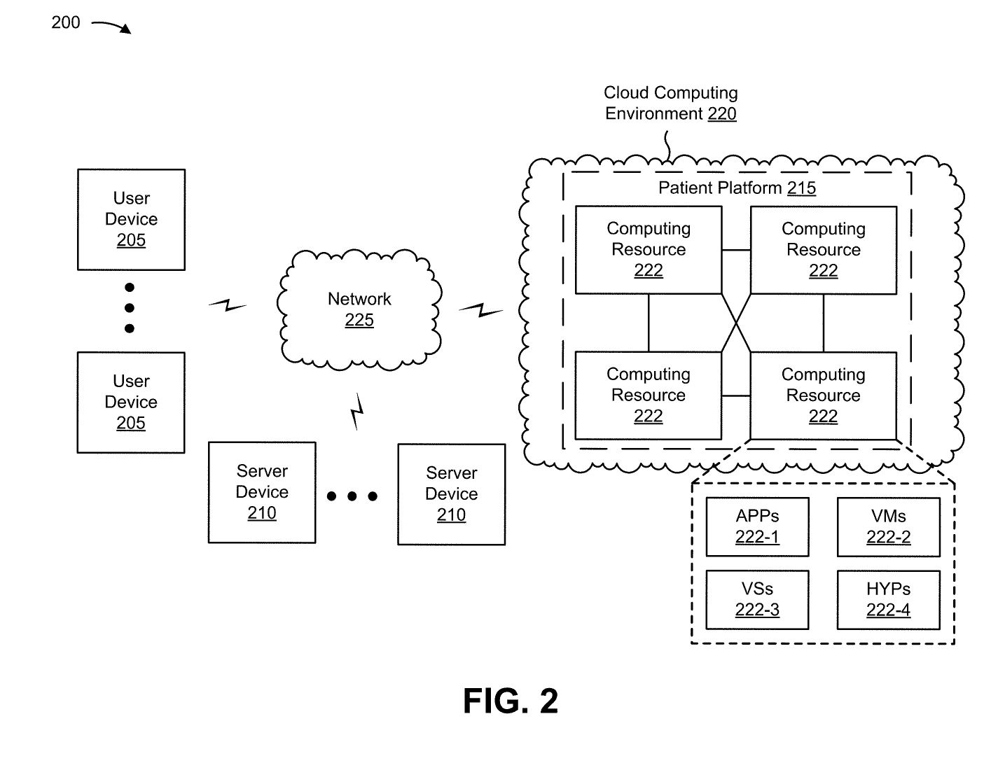

FIG. 2 is a diagram of an example environment 200 in which systems and/or methods described herein may be implemented. As shown in FIG. 2, environment 200 may include one or more user devices 205, one or more server devices 210, a patient platform 215 hosted within a cloud computing environment 220, and a network 225. Devices of environment 200 may interconnect via wired connections, wireless connections, or a combination of wired and wireless connections.

User device 205 includes one or more devices capable of receiving, generating, storing, processing, and/or providing information associated with patient platform 215, such as information associated with one or more applications of patient platform 215. For example, user device 205 may include a communication and computing device, such as a mobile phone (e.g., a smart phone, a radiotelephone, etc.), a laptop computer, a tablet computer, a handheld computer, a wearable communication device (e.g., a smart wristwatch, a pair of smart eyeglasses, etc.), or a similar type of device. In some implementations, user device 205 may include or be associated with one or more medical devices (e.g., sensors, monitors, etc.) via which data may be gathered.

Server device 210 includes one or more devices capable of receiving, collecting, obtaining, gathering, storing, processing, and/or providing information associated with a patient and/or a treatment associated with the patient. For example, server device 210 may include a server or a group of servers. In some implementations, server device 210 may include a device that stores or has access to patient information that is to be used by patient platform 215.

Patient platform 215 includes one or more devices capable of receiving, determining, processing, storing, and/or providing information associated with one or more patient services associated with a patient and/or operations associated with the patient. For example, patient platform 215 may include a server or a group of servers. In some implementations, patient platform 215 may host a suite of applications associated with the one or more patient services, such as a field nurse enablement application as described herein.

In some implementations, as shown, patient platform 215 may be hosted in cloud computing environment 220. Notably, while implementations described herein describe patient platform 215 as being hosted in cloud computing environment 220, in some implementations, patient platform 215 may not be cloud-based or may be partially cloud-based.

Cloud computing environment 220 includes an environment that hosts patient platform 215. Cloud computing environment 220 may provide computation, software, data access, storage, etc. services that do not require end-user (e.g., user device 205) knowledge of a physical location and configuration of system(s) and/or device(s) that hosts patient platform 215. As shown, cloud computing environment 220 may include a group of computing resources 222 (referred to collectively as “computing resources 222” and individually as “computing resource 222”).

Computing resource 222 includes one or more personal computers, workstation computers, server devices, or another type of computation and/or communication device. In some implementations, computing resource 222 may host patient platform 215. The cloud resources may include compute instances executing in computing resource 222, storage devices provided in computing resource 222, data transfer devices provided by computing resource 222, etc. In some implementations, computing resource 222 may communicate with other computing resources 222 via wired connections, wireless connections, or a combination of wired and wireless connections.

As further shown in FIG. 2, computing resource 222 may include a group of cloud resources, such as one or more applications (“APPs”) 222-1, one or more virtual machines (“VMs”) 222-2, virtualized storage (“VSs”) 222-3, one or more hypervisors (“HYPs”) 222-4, or the like.

Application 222-1 includes one or more software applications that may be provided to or accessed by user device 205. Application 222-1 may eliminate a need to install and execute the software applications on user device 205. For example, application 222-1 may include software associated with patient platform 215 and/or any other software capable of being provided via cloud computing environment 220. In some implementations, one application 222-1 may send/receive information to/from one or more other applications 222-1, via virtual machine 222-2.

Virtual machine 222-2 includes a software implementation of a machine (e.g., a computer) that executes programs like a physical machine. Virtual machine 222-2 may be either a system virtual machine or a process virtual machine, depending upon use and degree of correspondence to any real machine by virtual machine 222-2. A system virtual machine may provide a complete system platform that supports execution of a complete operating system (“OS”). A process virtual machine may execute a single program, and may support a single process. In some implementations, virtual machine 222-2 may execute on behalf of a user (e.g., user device 205), and may manage infrastructure of cloud computing environment 220, such as data management, synchronization, or long-duration data transfers.

Virtualized storage 222-3 includes one or more storage systems and/or one or more devices that use virtualization techniques within the storage systems or devices of computing resource 222. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 222-4 provides hardware virtualization techniques that allow multiple operating systems (e.g., “guest operating systems”) to execute concurrently on a host computer, such as computing resource 222. Hypervisor 222-4 may present a virtual operating platform to the guest operating systems, and may manage the execution of the guest operating systems. Multiple instances of a variety of operating systems may share virtualized hardware resources.

Network 225 includes one or more wired and/or wireless networks. For example, network 225 may include a cellular network (e.g., a long-term evolution (LTE) network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

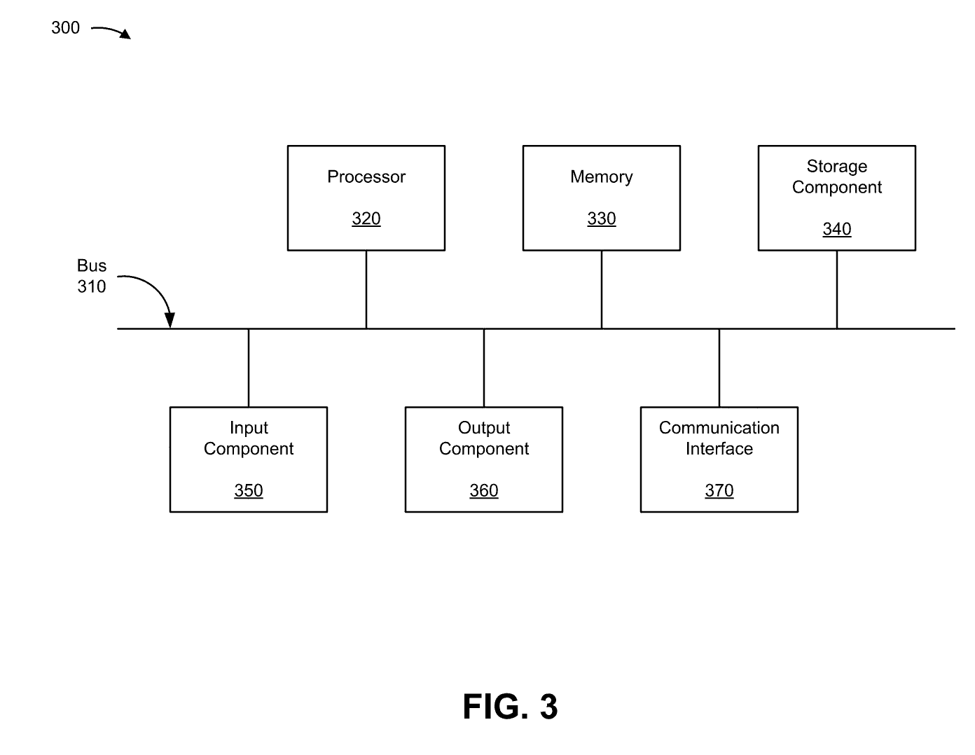

FIG. 3 is a diagram of example components of a device 300. Device 300 may correspond to user device 205, server device 210, patient platform 215, and cloud computing environment 220. In some implementations, user device 205, server device 210, patient platform 215, and/or cloud computing environment 220 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

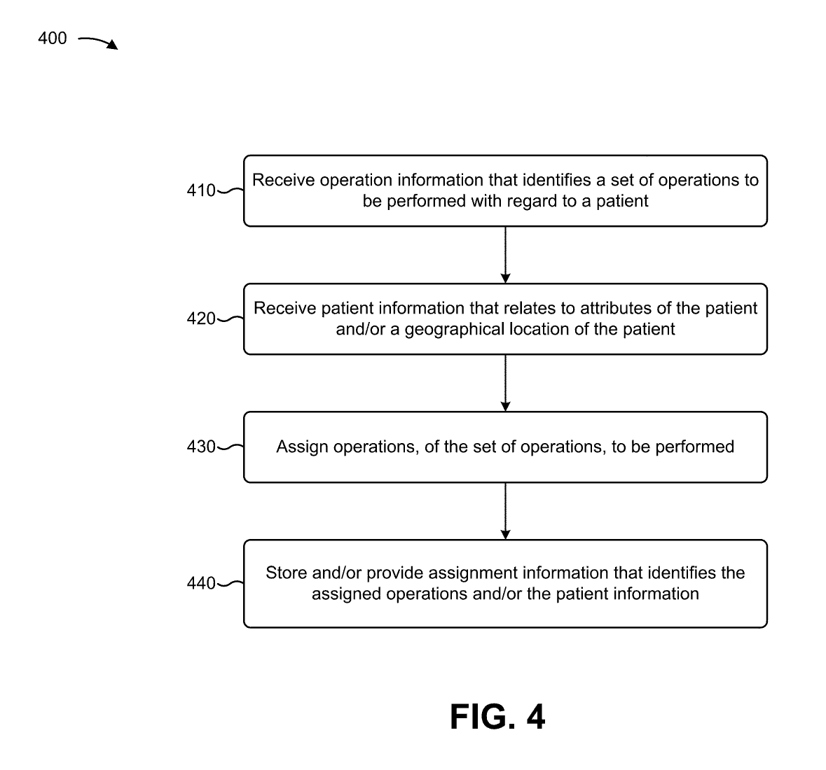

FIG. 4 is a flow chart of an example process 400 for configuring a set of operations to be performed with regard to a patient. In some implementations, one or more process blocks of FIG. 4 may be performed by patient platform 215 (e.g., patient platform 215 of cloud computing environment 220). In some implementations, one or more process blocks of FIG. 4 may be performed by another device or a group of devices separate from or including patient platform 215, such as user device 205 and/or server device 210.

As shown in FIG. 4, process 400 may include receiving operation information that identifies a set of operations to be performed with regard to a patient (block 410). For example, patient platform 215 may receive operation information. Patient platform 215 may receive the operation information from user device 205 (e.g., a user device 205 that is associated with a healthcare provider, an administrator, or the like), from server device 210, or from another device or entity. Patient platform 215 may receive, store, and/or provide information for use by workers to perform operations with regard to patients. As one possible example, patient platform 215 may correspond to the cloud server device described in connection with FIGS. 1A-1C, above.

The operation information may identify a set of operations to be performed with regard to a patient. The patient may include any recipient of services and/or health-related care, such as physician care, field nurse services, home health care, assisted living services, physical therapy, self-care training, occupational therapy, psychiatric care, life science services, or the like. For example, the patient may be a human patient, an animal subject to veterinary care, or the like. In some implementations, the patient may be any other party with regard to which an operation is to be performed. That is, a patient need not be a recipient of health care services. For example, the party may include a medical professional for whom training is to be provided, a physical location at which equipment is to be installed, or the like.

As examples, the set of operations to be performed may include enrolling a patient in treatment, performing treatment, providing treatment instructions (e.g., treatment adherence instructions), assessing patient condition (e.g., response to treatment), or the like. For example, the set of operations may include obtaining sensor measurements (e.g., temperature, blood pressure, or the like), providing therapy (e.g., physical therapy, occupational therapy, psychotherapy, or cardiac rehabilitation), administering medications (e.g., providing medications or providing information associated with medications), extracting and/or maintaining material (e.g., blood, tissue, or excretions) for diagnostic testing or donation, administering a survey (e.g., with respect to symptoms or side effects), measuring responses to stimuli, or the like. Other examples are possible, and the operations to be performed are not limited to the above examples. Indeed, an operation may include any action to be performed with regard to a patient.

In some implementations, the operation information may identify an order in which the operations are to be performed. For example, the operation information may identify dependencies of certain operations (e.g., operation A must be performed before operation B, or certain data must be obtained before performing a certain operation, etc.), conditional relationships between operations (e.g., perform operation A or operation B based on a result of performing operation C), or the like.

In some cases, the operation information may be configured based on a template that corresponds to a particular type of service. For example, the operation information (e.g., the operations prescribed by the operation information, the formatting of the operation information, etc.) may be configured based on a diabetes treatment template, a 12 week rehabilitation plan template, or a similar template. In some implementations, patient platform 215 may provide an interface (e.g., a user interface) for inputting the operation information based on the template. For example, the user interface may include elements that permit a user to specify particular operations to be performed, an order in which operations are to be performed, or the like. In such a case, patient platform 215 may process the operation information based on the template, which may conserve computing resources that would otherwise be used to process, normalize, or identify operation information that is not associated with a template.

In some implementations, patient platform 215 may receive or obtain the operation information automatically. For example, patient platform 215 may automatically generate the operation information according to a template and based on patient information associated with the patient (e.g., may generate an exercise program based on a height and weight of a patient). As another example, patient platform 215 may automatically receive the operation information periodically (e.g., for a weekly treatment to be administered to a patient, etc.). In some implementations, patient platform 215 may receive or obtain the operation information based on a user input. For example, a user may input the operation information to user device 205, and user device 205 may provide the operation information to patient platform 215.

As further shown in FIG. 4, process 400 may include receiving patient information that relates to attributes of the patient and/or a geographical location of the patient (block 420). For example, patient platform 215 may receive patient information from user device 205 (e.g., a user device 205 associated with a healthcare provider, a worker, an insurer, a patient, or the like), or from another device. In some implementations, the patient information may relate to attributes of, and/or medical information associated with, a patient associated with the operation information. For example, the patient information may relate to medical history, health indicators, patient-provided information, pharmaceuticals, performance on tasks, lab results, insurance information, provider notes, patient preferences, or the like. Additionally, or alternatively, the patient information may identify a geographical location of the patient. The geographical information may be based on a previously entered address, global positioning system (GPS) coordinates of a device associated with the patient, or the like. The geographical location may be used to assign workers to perform the set of operations based on locations of the workers and/or the patient, as described in more detail elsewhere herein.

In some implementations, the patient information may be received in association with the operation information (e.g., as part of a patient onboarding process). For example, patient platform 215 may receive the patient information from user device 205 associated with a healthcare provider, from server device 210 that stores patient information, or the like. As another example, patient platform 215 may receive patient information pertaining to the operations that are to be performed. For example, the patient information may include information that is useful to a worker that is to perform the operations. In some implementations, patient platform 215 may receive a complete medical history of a patient, may receive records relating to past operations performed by one or more workers, or the like.

In some implementations, patient platform 215 may receive the patient information from user device 205 associated with a worker. For example, the patient information may be received as the operations are performed (e.g., based on updates from user device 205 associated with a worker). In such a case, patient platform 215 may update patient information and/or operation information stored by patient platform 215, as described in more detail elsewhere herein.

In some implementations, the patient information may be encrypted when received. For example, encrypted patient information may be received from user device 205 (e.g., associated with a worker or associated with a healthcare provider), and patient platform 215 may decrypt the encrypted patient information. Additionally, or alternatively, patient platform 215 may encrypt the decrypted information before storing the patient information. Additionally, or alternatively, patient platform 215 may store the encrypted patient information without decrypting the patient information, which conserves computing resources of patient platform 215. In this way, security of the patient information may be improved.

As further shown in FIG. 4, process 400 may include assigning operations, of the set of operations, to be performed (block 430). For example, patient platform 215 may assign operations to be performed by one or more workers. A worker may include a nurse, a doctor, a physical therapist, a counselor, a technician, a residential staff member, a veterinarian, an automated device (e.g., for monitoring patient condition, releasing medication, or the like), or the like. In some implementations, patient platform 215 may assign the operations based on locations associated with the workers and the patient. For example, patient platform 215 may determine or receive information that identifies a route for a worker, and may assign patients that are located along the route. As another example, patient platform 215 may identify patients that are located near a worker, and may assign the patients to the worker based on proximity of the patients to the worker. As yet another example, patient platform 215 may identify multiple patients that are located close to each other, and may assign a worker to treat the multiple patients.

In some implementations, patient platform 215 may assign the operations based on capabilities of the workers (e.g., based on a qualification, based on past performance, or the like). In some implementations, patient platform 215 may assign the operations based on a combination of multiple factors. In such cases, patient platform 215 may assign the operations based on determining a score for a worker with regard to suitability to perform the operation. For example, patient platform 215 may determine a score based on comparing attributes, associated with the worker, to requirements associated with the operations. When a worker is associated with a satisfactory score for a particular operation (e.g., a score that satisfies a threshold, a highest score of a set of workers, a highest score of a set of workers within a threshold distance of a patient, etc.), patient platform 215 may assign the particular operation to be performed by the worker. Patient platform 215 may determine these scores based on a regression analysis, a least-squares analysis, a best fit analysis, a machine learning algorithm, or the like. In this way, patient platform 215 selects workers to perform operations based on multiple, different factors, which improves suitability of the workers to perform the operations.

As further shown in FIG. 4, process 400 may include storing and/or providing assignment information that identifies the assigned operations and/or the patient information (block 440). For example, patient platform 215 may provide, to user devices 205 corresponding to the workers, assignment information that identifies the operations assigned to the corresponding workers. In some implementations, the assignment information may include patient information associated with the patient or patients for which the operations are to be performed. For example, the assignment information may include information relevant to treatment, an image of the patient, a medical history of the patient, notes from other workers, an updated status of the patient since a last visit, or the like. Additionally, or alternatively, the assignment information may identify a geographical location associated with the patient. For example, the assignment information may include an address of the patient, coordinates of the patient, driving directions to the patient, an image of a dwelling of the patient, or the like.

In some implementations, patient platform 215 may provide encrypted assignment information. For example, patient platform 215 may encrypt the assignment information (e.g., upon determining and/or modifying the operations to assign) and may provide encrypted assignment information. Additionally, or alternatively, patient platform 215 may provide encrypted patient information. For example, patient platform 215 may encrypt the patient information, may provide patient information that was received in an encrypted state, or the like. In this way, security of the assignment information, and/or patient information associated with the assignment information, may be improved.

In some implementations, patient platform 215 may provide assignment information based on determining that patient platform 215 has established a secure connection with user device 205. For example, patient platform 215 may not provide assignment information when user device 205 is not securely connected to patient platform 215 (e.g., via a cellular connection, a Wi-Fi connection, or the like). As another example, patient platform 215 may not provide assignment information via an unsecure connection. In this way, security of patient information and/or assignment information may be improved.

In this way, patient platform 215 may improve the efficiency of providing and gathering patient information, assignment information, or the like. Furthermore, patient platform 215 may manage the patient information and assignment information using a centralized patient platform. Still further, patient platform 215 may improve security by encrypting assignment information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

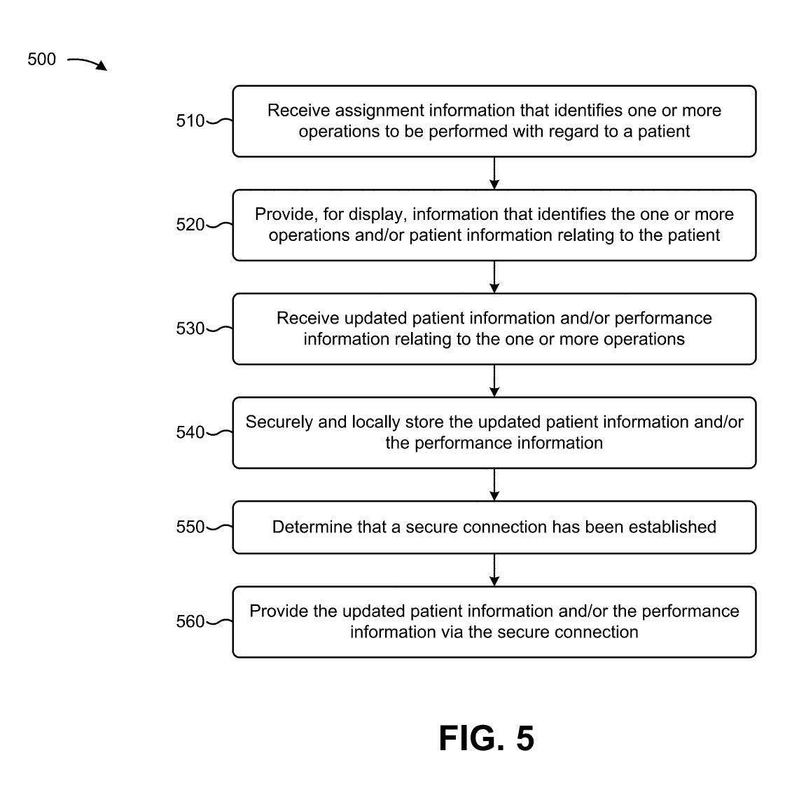

FIG. 5 is a flow chart of an example process 500 for securely administering and providing information related to performance of a set of operations. In some implementations, one or more process blocks of FIG. 5 may be performed by user device 205. In some implementations, one or more process blocks of FIG. 5 may be performed by another device or a group of devices separate from or including user device 205, such as patient platform 215 or server device 210.

As shown in FIG. 5, process 500 may include receiving assignment information that identifies one or more operations to be performed with regard to a patient (block 510). For example, user device 205 may receive assignment information from patient platform 215. The assignment information may identify operations to be performed with regard to one or more patients, as described in more detail in connection with FIG. 4, above. In some implementations, user device 205 may receive the assignment information in order to provide the assignment information to a worker (e.g., via a user interface) to support the worker in performing the one or more operations. For example, user device 205 may receive the assignment information to provide information useful for performance of the one or more operations, to gather observations from the worker, or the like.

In some implementations, user device 205 may receive the assignment information in order to gather sensor information pertaining to the one or more patients. In some implementations, sensor information may include information obtained via user device 205, such as via one or more sensors of user device 205 (e.g., a microphone, a camera, an accelerometer, a magnetometer, a gyroscope, or the like). For example, sensor information may include a photograph of a rash (e.g., developed after administration of a particular medication), or a recorded change in skin color (e.g., as may indicate a condition related to circulation), obtained via a camera of user device 205. Additionally, or alternatively, sensor information may include information obtained via a device, external to user device 205, that is capable of communication with user device 205, such as an electrocardiogram (ECG) monitor, a glucose monitor, a blood pressure monitor, a thermometer, or the like. User device 205 may gather the sensor information based on the assignment information (e.g., automatically, based on an instruction included in the assignment information, etc.), as described in more detail below.

In some implementations, the assignment information may be encrypted. For example, user device 205 may receive encrypted assignment information, and may decrypt the assignment information before storing the assignment information. Additionally, or alternatively, user device 205 may encrypt the assignment information before storing the assignment information locally. Additionally, or alternatively, user device 205 may receive and store the encrypted assignment information without decrypting the encrypted assignment information. As one example, user device 205 may use a particular technology, such as Core Data Structured Query Language (SQL) Lite technology, or a similar technology, for offline storage capabilities. As one possible example, the offline data encryption may be handled via a Federal Information Processing Standard (FIPS) CommonCrypto module and/or a SQLCipher that stores data as ciphertext in an encrypted SQLite file. In some implementations, SQLCipher may utilize 256-bit AES database encryption. Other encryption and security schemes are possible, and implementations described herein are not limited to the above encryption and security schemes.

In some implementations, user device 205 may provide access to the assignment information based on a credential. For example, user device 205 may require entry of a private key or password, may obtain and identify a fingerprint impression, may perform a retinal scan, may perform facial recognition, may perform another biometric process, or the like, to decrypt and/or provide access to the assignment information. In this case, the credential may be associated with user device 205, with a worker using user device 205, or both. Additionally, or alternatively, different workers may be associated with different credentials, thereby further increasing security of the process. In this way, user device 205 may provide secure access to locally stored assignment information, thereby improving security of the assignment information and reducing reliance of field-based workers on insecure information.

In some implementations, user device 205 may receive assignment information based on requesting assignment information. For example, user device 205 may receive an instruction to travel to a particular patient and, upon arriving at the particular patient, may request assignment information from patient platform 215. In such a case, the requested assignment information may pertain to treatment of the particular patient.

In some implementations, user device 205 may receive assignment information automatically. For example, user device 205 may automatically receive particular assignment information based on proximity to a patient associated with the particular assignment information (e.g., based on automatically reporting, to patient platform 215, that user device 205 is located near the patient). This may conserve processor resources that would otherwise be used to request the particular assignment information based on a manual interaction. Additionally, or alternatively, user device 205 may automatically receive the assignment information based on establishing a secure connection with patient platform 215. For example, patient platform 215 may automatically synchronize the assignment information to user device 205 based on determining that a secure connection has been established, which improves security of the assignment information and conserves resources of user device 205 that would otherwise be used to manually request the assignment information. In some implementations, user device 205 may receive assignment information for multiple, different patients, as described in more detail elsewhere herein.

In some implementations, patient platform 215 may provide modified assignment information to user device 205. The modified assignment information may be modified based on particular patient information and/or performance information pertaining to the patient. For example, user device 205 may upload, to patient platform 215 and in real-time or substantially real-time, updated patient information and/or performance information relating to operations previously performed with regard to the patient. Patient platform 215 may adjust the operations to be performed with regard to the patient based on the updated patient information and/or performance information. For example, assume that a field nurse monitors glucose levels for a patient, a time and volume of a last insulin dose of the patient, and information regarding predicted activity levels of the patient. User device 205 associated with the field nurse may provide updated patient information identifying the monitored values to patient platform 215 in real time or substantially real time.

In such a case, patient platform 215 may use a model, based on historical data and the updated patient information and/or performance information, to adjust dosage and/or timing of future insulin doses to be administered by the field nurse. Patient platform 215 may provide updated assignment information identifying the dosage and/or timing of future insulin doses to user device 205 associated with the field nurse and/or a user device 205 associated with the patient. Thus, treatment plans associated with a patient are updated in real-time or substantially real-time based on information gathered in the field, which improves provisioning of patient services, reduces asymmetry of data between field nurses and patient platform 215, and reduces delay in designing and provisioning treatment plans.

As further shown in FIG. 5, process 500 may include providing, for display, information that identifies the one or more operations and/or patient information relating to the patient (block 520). For example, user device 205 may provide, for display to a worker associated with user device 205, information that identifies the one or more operations and/or patient information relating to the patient. The patient information may permit the worker to provide health services and/or to perform the one or more operations identified by the assignment information. In some implementations, user device 205 may provide, for display, information that identifies one or more additional operations that have been assigned to user device 205 based on patient information and/or performance information previously received by patient platform 215.

In some implementations, user device 205 may provide, for display, patient information pertaining to a particular operation. For example, when the worker is to perform a particular operation (e.g., administration of a particular drug), user device 205 may provide patient information that is relevant to the particular operation (e.g., a medical history of patient reactions to the particular drug that the worker is to administer). As another example, user device 205 may receive an interaction with an element of a user interface relating to a particular operation, and provide information relating to the particular operation based on receiving the interaction. As yet another example, user device 205 may provide, for display, patient information only when user device 205 is located within a particular distance of a patient associated with the patient information.

In some implementations, user device 205 may provide patient information that includes a comprehensive patient history (e.g., including all data associated with a medical history associated with the patient or a history of operations performed for the patient). In some implementations, user device 205 may permit a user or worker to access the comprehensive patient history. For example, the comprehensive patient history may be stored locally, thus conserving network resources and allowing the worker to access the patient history when isolated from access to patient platform 215. As another example, the comprehensive patient history may be stored remotely (e.g., on server device 210 or patient platform 215), thus conserving storage resources of user device 205.

In some implementations, user device 205 may provide the patient information via an interactive user interface. In this case, the user interface may permit a worker to input information relating to one or more operations from user device 205 (e.g., results of operations, information relating to a patient, observations, or the like). The interactive user interface is described in more detail in connection with block 530, below.

As further shown in FIG. 5, process 500 may include receiving updated patient information and/or performance information relating to the one or more operations (block 530). For example, user device 205 may receive updated patient information and/or performance information. In some implementations, user device 205 may receive the updated patient information and/or the performance information via a graphical user interface. For example, the user interface may identify operations and/or patient information relating to the operations. As another example, the user interface may permit a worker to input performance information related to performing the one or more operations. In this case, the performance information may include information identifying results of an operation, information indicating that an operation is complete, information indicating that an operation could not be completed, or the like. In a situation where the operation information relates to an entity other than a patient (e.g., when the operation information relates to equipment to be installed at a location, to tasks to be performed by an insurance adjuster, to training to be provided for a medical professional, etc.), the updated patient information may be referred to as “updated entity information.”

In some implementations, user device 205 may configure the user interface based on a particular operation to be performed. For example, if an operation is associated with training the patient to perform a task, user device 205 may provide a portion of the user interface via which a worker may take down notes regarding progress of the patient toward performing the task. Additionally, or alternatively, an entity that provides the assignment information and/or manages the patient information may configure the user interface, so that the content of the user interface identifies the information that the worker is to gather and report. For example, when an operation is specified by an insurance provider, user device 205 may provide a user interface that is configured to collect information associated with the insurance provider.

In some implementations, user device 205 may perform an action based on the assignment information. For example, when user device 205 is to obtain a sensor measurement, the assignment information may include an instruction to cause user device 205 to obtain the sensor measurement (e.g., based on an integrated sensor of user device 205, based on a sensor that is connected to or tethered to user device 205, or the like). In this way, patient platform 215 causes user device 205 to automatically perform an action, which may improve accuracy of data determined based on the action, and which may conserve resources of user device 205 (e.g., processor and/or battery resources) that would otherwise be used to manually cause user device 205 to perform the action.

In some implementations, user device 205 may receive sensor information based on a worker performing an operation. For example, the operation may include attaching a sensor to a patient, and user device 205 may receive sensor information from the sensor. In some implementations, user device 205 may obtain the sensor information automatically. For example, user device 205 may receive the sensor information based on user device 205 being at a particular location, based on user device 205 connecting with a sensor, or the like.

In some implementations, user device 205 may receive adverse event information. An adverse event is an unfavorable or unintended sign, symptom, or disease that is temporally associated with the use of a medicinal product. In some environments, a worker may be required to report adverse events to an entity associated with the medicinal product, to a government entity, or the like. The adverse event information may include information identifying a medicinal product, a patient reaction to the medicinal product, sensor information associated with the adverse event, recorded media (e.g., one or more images, videos, or audio recordings), or the like.

In some implementations, user device 205 may receive an indication that an adverse event is occurring, and may prompt a user for additional information regarding the adverse event. For example, a worker may input information that indicates that an adverse event is occurring and, based on the information, user device 205 may prompt the user for additional information. The additional information may include medication information, patient reaction information, images of a patient, comments from the worker, or the like. User device 205 may provide the additional information to an entity (e.g., a pharmaceutical company, a government entity, etc.) in a standards-compliant and/or secure manner (e.g., directly, via patient platform 215, etc.). In this way, user device 205 may record and securely store adverse event information, which may reduce usage of computational resources that would otherwise be used to gather and record adverse event information in a disorganized fashion.

As further shown in FIG. 5, process 500 may include securely and locally storing the updated patient information and/or the performance information (block 540). For example, user device 205 may securely and locally store the updated patient information and/or the performance information. In some implementations, user device 205 may encrypt the updated patient information and/or the performance information. For example, user device 205 may encrypt the data using Core Data SQL Lite technology, as described above. Additionally, or alternatively, user device 205 may store the updated patient information and/or the performance information locally (e.g., in memory of user device 205). In this way, security of the updated patient information and/or the performance information may be improved.

In some implementations, user device 205 may prevent one or more workers from accessing the updated patient information and/or the performance information. For example, if user device 205 is shared among multiple workers, user device 205 may prevent workers, other than a worker that performed the operations, from accessing the updated patient information and/or the performance information (e.g., based on respective credentials associated with the workers). In this way, security of the information may be improved. In such cases, user device 205 may provide the worker that performed the operations with access to the updated patient information and/or the performance information (e.g., based on a credential associated with the worker that performed the operations). In some implementations, user device 205 may prevent any worker from accessing the updated patient information and/or the performance information, thereby further increasing security of the updated patient information and/or the performance information.

In some implementations, after user device 205 stores data, user device 205 may prevent access to the data until the data is provided to patient platform 215, which improves security of the data. In some implementations, memory of user device 205 on which the data is stored may be tamper-proof or tamper-resistant. Thus, if user device 205 is lost or stolen, a malicious entity may be prevented from accessing the contents of the memory. In some implementations, attempting to access the memory of user device 205 may cause contents of the memory of user device 205 to be destroyed. Additionally, or alternatively, attempting to access the memory of user device 205 may cause the contents of the memory to be automatically uploaded and then destroyed, thereby further improving security of the information.

As further shown in FIG. 5, process 500 may include determining that a secure connection has been established (block 550). For example, user device 205 may determine that a secure connection with patient platform 215 has been established. In some implementations, user device 205 may store the updated patient information and/or the performance information until a secure connection (e.g., a connection via a cellular or Wi-Fi network, a connection via the Internet, an encrypted Session Initiation Protocol (SIP) session, a Transport Layer Security (TLS) session, a Hypertext Transfer Protocol Secure (HTTPS) session, a File Transfer Protocol (FTP) session, or the like) has been established with patient platform 215. In this way, workers may perform operations based on patient information without an active connection to patient platform 215, and the security of stored data may be improved. When a secure connection is established, user device 205 may provide, to patient platform 215, the updated patient information and/or the performance information via the secure connection, as described in more detail below.

As further shown in FIG. 5, process 500 may include providing the updated patient information and/or the performance information via the secure connection (block 560). For example, user device 205 may provide the updated patient information and/or the performance information via the secure connection. In some implementations, user device 205 may provide updated patient information and/or the performance information in an encrypted form, which improves security and reduces processor usage of user device 205 to decrypt the updated patient information and/or the performance information. In some implementations, user device 205 may decrypt the updated patient information and/or the performance information before providing the updated patient information and/or performance information, which may conserve processor resources of patient platform 215. In some implementations, user device 205 may provide information only when a secure connection with patient platform 215 is established, which improves security of the information.

In some implementations, user device 205 may establish a secure connection based on a location of user device 205. For example, user device 205 may store or have access to information indicating that a particular location (e.g., a hospital, a rehabilitation facility, a particular ZIP code, etc.) is a secure location, and user device 205 may provide information to patient platform 215 only when user device 205 is located at the secure location. In such a case, user device 205 may automatically provide the information when located at the secure location. For example, user device 205 may determine that a location of user device 205 matches the secure location, and may automatically provide the information based on determining that the location matches the secure location. In this way, user device 205 improves efficiency of performance of the operation, ensures the integrity of the information stored by user device 205, and ensures the security of the information being provided to patient platform 215.

In some implementations, user device 205 may obtain new patient information and/or assignment information from patient platform 215 based on establishing the secure connection. For example, user device 205 may synchronize with patient platform 215 when a secure connection is active, and may securely store data to be provided to patient platform 215 when a connection is not active. In this way, user device 205 may improve worker activity when user device 205 is offline, and may synchronize updated patient information and/or the performance information to patient platform 215 when user device 205 is online. Further, as multiple, different user devices 205, associated with different workers, establish connections with patient platform 215, the multiple, different user devices 205 may obtain the new patient information and/or assignment information. Thus, synchronization of field workers is improved and asymmetry of data is reduced.

In some implementations, patient platform 215 may update operation information and/or patient information based on receiving updated patient information and/or performance information from user device 205. For example, user devices 205 may provide, to patient platform 215, performance information and/or updated patient information for patients associated with the operations. Patient platform 215 may update operation information based on the performance information and/or the updated patient information. For example, based on performance information that identifies results of a first set of operations pertaining to a patient, patient platform 215 may assign a second set of operations to be performed with regard to the patient. As another example, based on a result of a first operation, patient platform 215 may select one or more second operations to be performed with regard to a patient (e.g., based on a conditional associated with the first operation). In such cases, patient platform 215 may provide assignment information and/or updated patient information, relating to the updated operation information, to user devices 205 associated with workers who are to perform the one or more second operations.

In some implementations, patient platform 215 may synchronize the updated patient information and/or the performance information to other user devices 205 and/or server devices 210. For example, a first worker may obtain patient information while providing services to a patient, and may input the patient information to a first user device 205 associated with the first worker. When a secure connection is established, the first user device 205 may provide the patient information to patient platform 215, and patient platform 215 may update the patient information associated with the patient. Patient platform 215 may then provide the updated patient information to other user devices 205, and other workers using the other user devices may utilize the patient information to provide services to the patient.

As a particular example, assume that a worker visits a patient on a particular day and inputs patient information, regarding the patient, to a first user device 205. Assume further that the first user device 205 provides the patient information to patient platform 215, and that patient platform 215 synchronizes the patient information to a second user device 205 associated with a call center. Assume that the patient calls the call center to obtain the patient information on the next day. When the patient calls the call center for additional information regarding the visit, the call center personnel may have access to the requested information to provide to the patient. Thus, information asymmetry between devices associated with health care providers and redundant entry of information are reduced. Further, security of the patient information is improved when transferred among health care providers.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

Implementations described herein enable workers to provide health related services, in locations potentially remote from a computer system where patient information and/or assignment information is maintained, in a way that allows the workers to access, utilize, and/or update the information in real time (or near real time), to securely maintain the information, and to provide the information to the computer system when it is possible to do so (e.g., as soon as a secure connection may be established).

For example, patient platform 215 may provide, to user device 205 of a healthcare worker, patient information, and/or assignment information identifying services to be performed by the worker. User device 205 may obtain updated information based on services performed, measurements obtained, and/or adverse events recorded, and may securely store the updated information until a secure connection can be established with patient platform 215, at which point patient platform 215 may obtain and store the updated information. The updated information may thereafter by provided to other user devices 205 and/or to other workers providing services to the patient.

In this way, resources may be saved (e.g., processor, memory and/or storage) that may otherwise be used to redundantly store or provide information. Furthermore, information asymmetry (e.g., based on out-of-date records) may be reduced. Further still, patient data may be gathered, enriched, and analyzed more efficiently. The provision of patient care and the experience of the patient may thereby be improved.

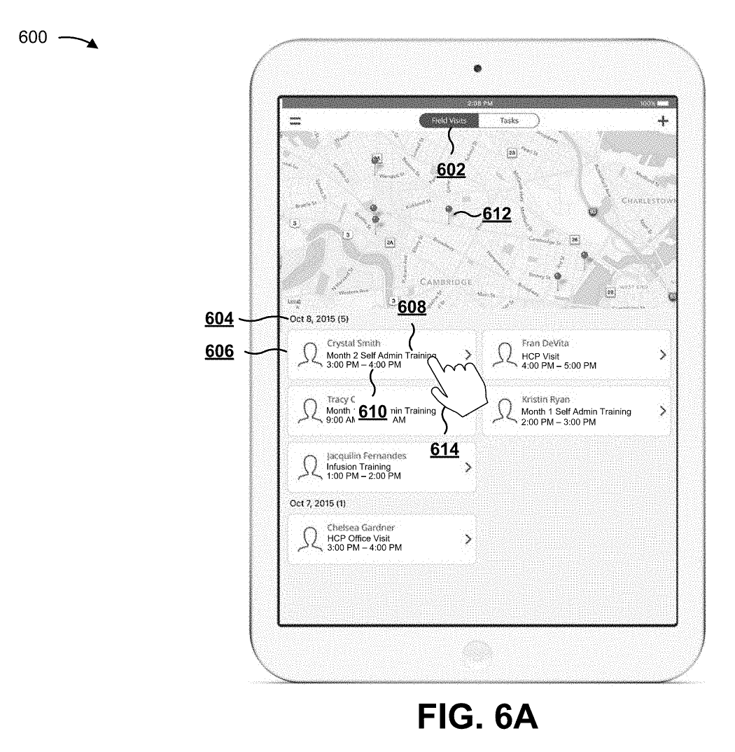

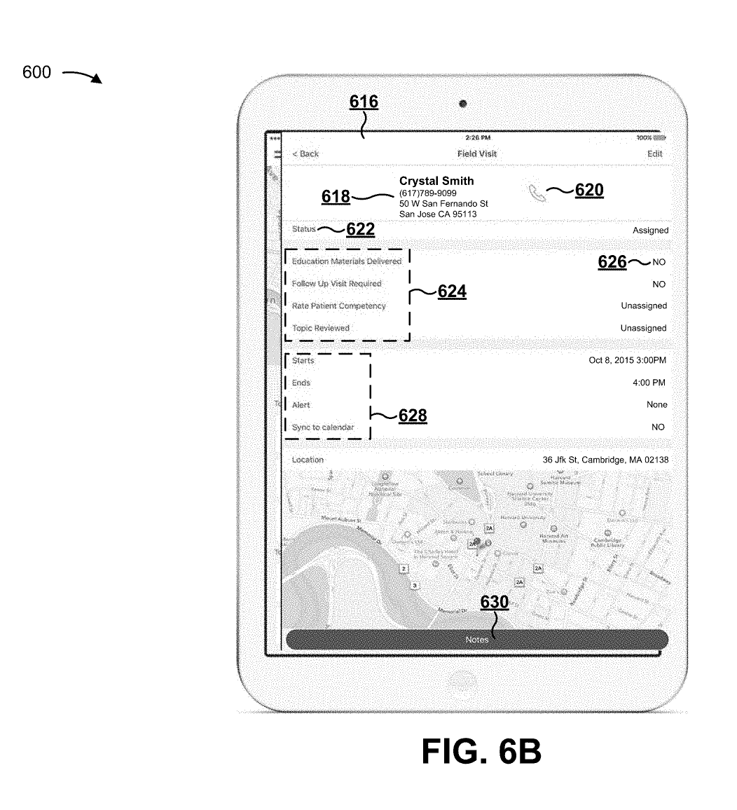

FIGS. 6A and 6B are diagrams of example user interfaces 600 that relate to example processes 400 and 500 shown in FIGS. 4 and 5. As shown in FIG. 6A, user device 205 may display user interface 600 which may provide, based on a user selection of a Field Visits button (shown by reference number 602), a plan view, which may provide information relating to each patient for which the worker has been assigned operations on a particular day. The particular day may be identified by a date field (shown by reference number 604) which shows a relevant date (e.g., a current date, or a selected date) and a number of visits (shown in parentheses) to be made to different patients on the relevant date. Each patient to be visited on the relevant date may be represented by a patient field (shown by reference number 606) which may include the name of the patient, an identifier of the services to be performed for the patient (shown by reference number 608), and the scheduled time of the visit to the patient (shown by reference number 610).

User interface 600 may further include a map view showing locations of all patient visits to be made on the relevant date, with the location of each patient to be visited being represented by an image of a pin on the map (shown by reference number 612). As shown by reference number 614, based on an interaction with a portion of the user interface corresponding to a patient field associated with a selected patient, user device 205 may display user interface 600 in a specific Field Visit view for the selected patient, as is described below.

As shown in FIG. 6B, user device 205 may display user interface 600 in a Field Visit view (shown by reference number 616) for a selected patient based on receiving a user selection of the selected patient, as described above. In the Field Visit view, user interface 600 may include a contact field (shown by reference number 618) that provides a name, address, phone number, or the like, of the patient. The worker may use this information to contact or travel to the patient. User interface 600 may further include a call button (shown by reference number 620), which may cause user device 205 to call the patient at the phone number. In some cases, the call button may cause user device 205 to cause an emergency line, a health care practitioner associated with the patient, or the like.

As further shown, user interface 600 may include a status field (shown by reference number 622) which indicates a status of the visit (e.g., Assigned, Completed, or the like). An assigned visit may be associated with an operation that has yet to be performed. A completed visit may be associated with an operation that has already been performed.

User interface 600 may further include a services section (shown by reference number 624) which lists operations to be performed, and which shows a status of each service (shown by reference number 626). Here, the operations include delivering educational materials (associated with an uncompleted status of NO), performing a follow-up visit (associated with an uncompleted status of NO), providing a rating of patient competency (associated with an unassigned status, indicating that the operation has not been assigned to a worker), and reviewing a topic (associated with an unassigned status, indicating that the operation has not been assigned to a worker. In some implementations, the worker may change the status of an operation by selecting an operation field or the associated status field, which may cause user device 205 to prompt the worker to enter updated information.

User interface 600 may further include a scheduling section (shown by reference number 628) which shows a start and end time for the visit (e.g., a scheduled start time and end time, an actual start time and end time, an adjusted start time and end time based on extenuating circumstances, etc.), an indication of whether an alert has been set (e.g., a pop-up alert to remind a worker of the visit, an alert to be transmitted to the patient when the visit is about to occur, etc.), and an indication of whether the visit has been synchronized to a calendar (e.g., a calendar stored by user device 205, a calendar associated with the worker, a calendar associated with the patient, etc.). In some implementations, user device 205 may change the start time or end time, or may set an alert, or may enable a synchronization to a calendar, based on receiving an interaction with the corresponding field or status, which may cause user device 205 to prompt the worker to enter updated information. As further shown, user interface 600 further includes a Notes button, which the worker may select to enter or view notes associated with the visit (e.g., notes that do not relate to an operation, notes in response to a prompt provided by user device 205, etc.).

As indicated above, FIGS. 6A and 6B are provided merely as examples. Other examples are possible, and may differ from what was described with regard to FIGS. 6A and 6B.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive assignment information that identifies one or more operations to be performed with regard to a patient,
provide, for display via a user interface, information identifying the one or more operations and first patient information relating to the patient,
the first patient information relating to performance of the one or more operations with regard to the patient;
receive, via the user interface, one or more of:
performance information based on performance of the one or more operations, or
second patient information relating to the patient; and
provide the performance information or the second patient information to permit modification of the one or more operations, or assignment of one or more additional operations to be performed, based on the performance information or the second patient information.

2. The device of claim 1, where the one or more processors are further to:
receive the first patient information based on the device being located at a location associated with the patient.

3. The device of claim 1, where the one or more processors, when providing the information identifying the one or more operations and the first patient information for display, are further to:
provide, via the user interface, information identifying a location associated with the patient.

4. The device of claim 1, where the one or more processors are to:
securely and locally store the performance information or the second patient information;
determine that a secure connection has been established; and
where the one or more processors, when providing the performance information or the second patient information, are to:
provide the performance information or the second patient information via the secure connection.

5. The device of claim 4, where the one or more processors, when securely and locally storing the performance information or the second patient information, are to:
prevent access to the performance information or the second patient information until the performance information or the second patient information is provided.

6. The device of claim 4, where the device is capable of or permitted to establish the secure connection when the device is located in a geographical area.

7. The device of claim 1, where the performance information identifies one or more of:
one or more completion states of the one or more operations,
information obtained by the device based on performing the one or more operations, or
user-inputted information regarding performance of the one or more operations.

8. A method, comprising:
receiving, by a device, assignment information that identifies one or more operations to be performed with regard to a patient;
providing, by the device for display via a user interface, information identifying the one or more operations and first patient information relating to the patient,
the first patient information relating to performance of the one or more operations with regard to the patient;
receiving, by the device, one or more of:
performance information obtained based on performance of the one or more operations, or
second patient information relating to the patient; and
providing, by the device, the performance information or the second patient information to facilitate modification of the one or more operations, or assignment one or more additional operations to be performed, based on the performance information or the second patient information.

9. The method of claim 8, where the first patient information identifies one or more of:
medical information relating to the patient, or
a geographical location associated with the patient.

10. The method of claim 8, where providing the first patient information for display further comprises:
providing a portion of the first patient information for display,
the portion of the first patient information being provided for display based on the portion of the first patient information being needed to perform the one or more operations.

11. The method of claim 8, further comprising:
preventing access to the performance information or the second patient information until the performance information or the second patient information is provided.

12. The method of claim 8, where the first patient information is encrypted; and
where the method further comprises:
decrypting the first patient information before providing the first patient information for display,
the first patient information being decrypted based on a credential received by the device.

13. The method of claim 8, further comprising:
receiving information indicating that an event has occurred; and
providing, via the user interface, a prompt to cause a user to provide information relating to the event.

14. The method of claim 8, where the assignment information is first assignment information; and
where the method further comprises:
receiving second assignment information that identifies the one or more additional operations; and
providing, for display, particular patient information, of the first patient information or the second patient information,
the particular patient information relating to performance of the one or more additional operations.

15. A non-transitory computer-readable medium storing instructions, the instructions comprising:
one or more instructions that, when executed by one or more processors of a device, cause the one or more processors to:
receive assignment information that identifies one or more operations to be performed with regard to a patient,
provide, for display via a user interface, information identifying the one or more operations and first patient information relating to the patient,
the first patient information facilitating performance of the one or more operations with regard to the patient;
receive, via the user interface, one or more of:
performance information that is received based on the one or more operations being performed, or
second patient information relating to the patient; and
provide the performance information or the second patient information;
receive, based on the performance information or the second patient information, updated assignment information,
the updated assignment information identifying one or more additional operations to be performed; and
provide, via the user interface, information regarding the one or more additional operations,
the information regarding the one or more additional operations being provided to facilitate performance of the one or more additional operations.

16. The non-transitory computer-readable medium of claim 15, where the first patient information relates to a medical history of the patient or a geographical location associated with the patient.

17. The non-transitory computer-readable medium of claim 15, where the one or more operations include a plurality of operations; and
where the one or more instructions, that cause the one or more processors to provide the information identifying the plurality of operations, further cause the one or more processors to:
provide a first portion of the first patient information, that relates to a first operation, of the plurality of operations, for display when the first operation is to be performed; and
provide a second portion, of the first patient information, that relates to a second operation, of the plurality of operations, for display when the second operation is to be performed.

18. The non-transitory computer-readable medium of claim 15, where the one or more instructions, when executed by the one or more processors, cause the one or more processors to:
automatically obtain sensor information based on the assignment information; and
where the one or more instructions, that cause the one or more processors to provide the performance information, cause the one or more processors to:
provide the sensor information.

19. The non-transitory computer-readable medium of claim 15, where the one or more instructions, that cause the one or more processors to provide the performance information or the second patient information, cause the one or more processors to:
provide the performance information or the second patient information based on the device being located at a particular location.

20. The non-transitory computer-readable medium of claim 15, where the one or more instructions, that cause the one or more processors to receive the assignment information, cause the one or more processors to:
receive the assignment information based on the device being located at a location associated with the patient.
